(19) United States
(12) Patent Application Publication
(10) Pub. No.: US 2019/0242414 A1
(43) Pub. Date: Aug. 8, 2019

(54) Device Indicating the Loosening of a Nut

(71) Applicant: TOTAL RAFFINAGE CHIMIE, Courbevoie (FR)

(72) Inventors: Pedro Nascimento, Le Havre (FR); Gael Chevalier, Sainte-Adresse (FR); Matthew Allen, Orange, TX (US); Denis Loozen, Ixelles (BE); Didier Peltier, Creutzwald (FR)

(21) Appl. No.: 16/343,215

(22) PCT Filed: Oct. 9, 2017
(86) PCT No.: PCT/EP2017/075686

§ 371 Date: Apr. 18, 2019

(30) Foreign Application Priority Data
Oct. 18, 2016 (FR) 1660076

(51) Int. Cl. F16B 1/00; F16B 37/14

(52) U.S. Cl. CPC F16B 1/0071; F16B 37/14

(57) ABSTRACT

A device (1) for indicating loosening of a rotary element (2) of a screw-and-nut system, this rotary element being intended to be screwed by a movement in rotation about a longitudinal direction (D), said rotary element comprising a portion of polygonal section in a plane normal to the longitudinal direction, said polygonal section portion defining a plurality of plane faces (21, 22, 23, 24, 25, 26), said indicator device comprising
a body (3) intended to be mounted on the rotary element,
a marking element (4) extending radially, fastened to the body to indicate the angular position of the rotary element, and
at least one spring (31, 32, 33, 34, 35, 36) fastened to the body so that when the body is mounted on the polygonal section portion each spring exerts a radial bearing force on a corresponding plane face of the rotary element.

The invention concerns a device indicating the loosening of a nut.

Screw-and-nut systems are routinely used for the assembly of parts, notably in industry and on motor vehicles. Nevertheless, diverse factors, in particular the vibrations suffered, the variations of temperature, an insufficient initial tightening, are liable to generate loosening in the long term.

In an industrial installation loosening of this kind risks leading to a leak.

There exist already on the market loosening indicators for the nuts of truck wheels. The document GB 2242720 describes one example of a loosening indicator for truck wheels of the type known in the prior art.

That device comprises a hollow circular body intended to be mounted around the nut and in one piece with a visual marker in the shape of an arrow. The internal wall of the hollow circular body defines fine grooves for fixing it to edges of the nut.

Using a device of this kind in an industrial environment has been envisaged but there is a risk of it proving unsatisfactory because the nuts are liable to be corroded, impacted and the environment is confined, sometimes with relatively high temperatures, of the order of 200° or more.

The loosening indicators presently on the market are actually intended for use at ambient temperature, for nuts in good condition, and with a small overall size around the nut.

The document U.S. Pat. No. 8,152,426 describes another device in which the internal walls have a tapered shape and are made of silicone so as to be gripped against the edges of the nut. Again, however, because of the deformation of the silicone there is the risk of this device not proving satisfactory in a confined environment subjected to high temperatures, notably if the device is removed and installed on another nut.

On industrial sites permanent marking of the nut is therefore used, with paint on metal. Nevertheless, this marking remains liable to disappear over time and to be relatively poorly visible for an observer relatively far from the nut.

There is therefore a need for a nut loosening indicator device that is usable in an industrial environment, stable and visible from far away, in particular from more than 30 cm away.

There is proposed a device for indicating loosening of a rotary element of a screw-and-nut system, this rotary element being intended to be screwed in and out by a movement in rotation about a longitudinal direction, said rotary element comprising a portion of polygonal section in a plane normal to the longitudinal direction, said polygonal section portion defining a plurality of plane faces, said indicator device comprising

a body intended to be mounted on the rotary element,

a marking element extending radially, fastened to the body to indicate the angular position of the rotary element.

According to the invention at least one spring is fastened to the body so that when the body is mounted on the polygonal section portion each spring exerts a radial bearing force on a corresponding plane face of the rotary element.

Accordingly, rather than cooperate with the edges of the rotary element, which may prove relatively unreliable in an industrial environment where those edges may be poorly defined or damaged, the indicator device described above includes one or more springs bearing on the plane faces of the rotary element.

The device described above can therefore remain operational in an industrial environment, and in particular in a refinery. In particular, this device may easily be demounted from the rotary element and then mounted again with no risk of deterioration of the fixing to the rotary element.

A single spring may be provided or a small number of springs compared to the number of plane faces, but at least one spring for each plane face will advantageously be provided.

The invention is not limited by the shape of the rotary element for which this device is intended, provided that this element includes a portion with plane faces and having a polygonal section.

The rotary element may be a nut in the classic sense of the term, defining an internally threaded opening intended to receive and to cooperate with a externally threaded screw. It may for example be a screw end.

The nut may be a hexagonal, square blind or through nut, with or without a base (in the former case the polygonal section portion occupies only a part of the height of the nut).

Alternatively, the rotary element may be fastened to, for example in one piece with, an externally threaded rod, that rod being itself screwed into a bore.

The plane faces of the rotary element may be peripheral or not. For example, and in particular when the rotary element is at the end of the externally threaded rod, the rotary element may define a closed central orifice of hexagonal shape. The rotary element may therefore comprise a hollow hexagonal screw. In this case, the springs of the loosening indicator device may be disposed at a periphery of the body and the body may have dimensions sufficiently small to be received in the central orifice.

The body of the indicator device may advantageously comprise internal walls defining a recess to receive the rotary element and the springs may be disposed on those internal walls.

Neither is the invention limited to the shape of the springs of the indicator device. There may for example be provided a body comprising a ring element of polygonal shape to which is fixed a corrugated band or a body with a polygonal ring element with plane internal walls and into which is fixed on one of the internal walls one end of a relatively rigid coil spring so that when a nut is received this spring exerts radial forces toward the nut.

The spring may advantageously comprise a leaf spring.

Each leaf spring may extend between two ends fastened to the body.

Each leaf spring may have a length slightly greater than the length of the corresponding plane face.

The body may be such that when a rotary element is received at least one of its plane faces comes to compress the corresponding spring so that this leaf spring exerts a radial bearing force on that face.

The invention is not limited to a particular shape of the body, but the body may advantageously comprise at least one ring element for example of polygonal or circular shape.

A circular shape may provide more freedom in the positioning of the marking element when that element is initially separate from the body.

The leaf springs may be fastened at their two ends to an internal wall of the ring element so as to form a pseudo-polygonal structure to receive the polygonal section portion of the rotary element.

The marking element may extend radially toward the interior of the body and/or toward the exterior. This element may for example have an arrow, rod or other shape.

The analysis of tightening quality can therefore be relatively simple and rapid to carry out, even by unqualified personnel and at a relatively great distance from the nut.

In one embodiment, the marking element may be in one piece with the body. The indicator device can therefore be relatively simple to manufacture.

Alternatively, the indicator device may be such that the marking element can be assembled to the body.

In particular, the indicator device may be such that the marking element can be assembled to the body at a plurality of locations on the body, for example 2, 4 or more locations.

In a nonlimiting manner, the number of locations may advantageously be greater than 20, advantageously greater than 50, advantageously greater than 60. The marking element can therefore be fixed at a relative precisely chosen position, the pitch between two positions possibly being relatively small—of the order of a few degrees.

The invention is not limited by the type of fixing employed. For example, fixing may be provided by gripping at least one relatively soft element of the rubber or silicone type.

In one embodiment, the marking element may be clippable onto the body.

In another embodiment, the body and the marking element may define cooperating means complementary to one another with a depth in the radial direction varying according to the angular position with a particular pitch, for example teeth adapted to fit in one another, tongues and grooves, studs and corresponding recesses, etc.

These cooperation means may define a relatively small pitch, for example of a few degrees.

These cooperation means, for example a system of studs and recesses, may be adapted to prevent both tangential and radial relative movement.

Alternatively, these cooperation means, for example a system with teeth or tongues, may be adapted simply to prevent tangential relative movement.

In this case in particular, the indicator device comprises a wall facing the cooperation means of the marking element or the cooperation means of the body can be such that the walls retained by these cooperation means fit in one another.

Alternatively, the marking element could comprise a toothed (or ribbed, notched or other) closed, for example circular, element. The cooperation between teeth of the body and teeth of the marking element then occurs over all the circumference of the indicator device.

In one embodiment the cooperation means of the body may be disposed on an external periphery of that body, those means then being open toward the exterior. The marking element can then define two walls facing one another, the internal face of the outermost wall defining cooperation means oriented toward the interior of the device. These two walls are at a distance such that the innermost wall can maintain the cooperation means fit in one another.

In another embodiment the body may comprise two concentric, for example circular, ring elements.

The internal wall of one of these concentric ring elements may define cooperation means complementary to cooperation means of the marking element. A portion of the marking element is then inserted into the space between these concentric elements, the cooperation means preventing all tangential relative movement.

The marking element may comprise a small number of cooperation means, for example one or two studs or tongues.

The indicator device described above may be made of metal, of plastic, for example of a plastic stable from −20° to 250°, or some other material. Polypropylene or ABS (acrylonitrile butadiene styrene) could for example be chosen.

Producing it in metal enables use of the indicator device at even higher temperatures, of the order of 500° or 600°, or even 1500° C. if produced in titanium.

A 3D printer could in particular be used to produce this device.

In one embodiment, the body may define, for example on the external periphery of the external ring element, means for fixing it to a linear element, for example a cable, a wire, for example a metal wire, etc.

Thus there is proposed an assembly for maintaining in a tightened position a plurality of rotary elements, each rotary element being intended to be screwed in and out by a movement in rotation about a longitudinal direction, this assembly comprising

at least two retaining devices adapted to be mounted on respective rotary elements so as to prevent all relative movement in a tangential direction, for example by means of two loosening indicators as described above, each retaining device comprising means for fixing it to a linear element,

the linear element fixed to two retaining devices via respective corresponding fixing means so that a loosening movement of one of the rotary elements corresponding to one of those retaining devices drives the rotary element corresponding to the other of those retaining devices in rotation in the tightening direction.

The rotary elements are thus fastened to one another in such a manner as to limit loosening.

The retaining devices may be indicator devices as described above or not. An indicator device of the type known from the prior art could in particular be used.

There is further proposed a use of the indicator device described above and/or of the assembly described above in a petrochemical installation.

The invention will be better understood on referring to the figures, which show embodiments given by way of nonlimiting example.

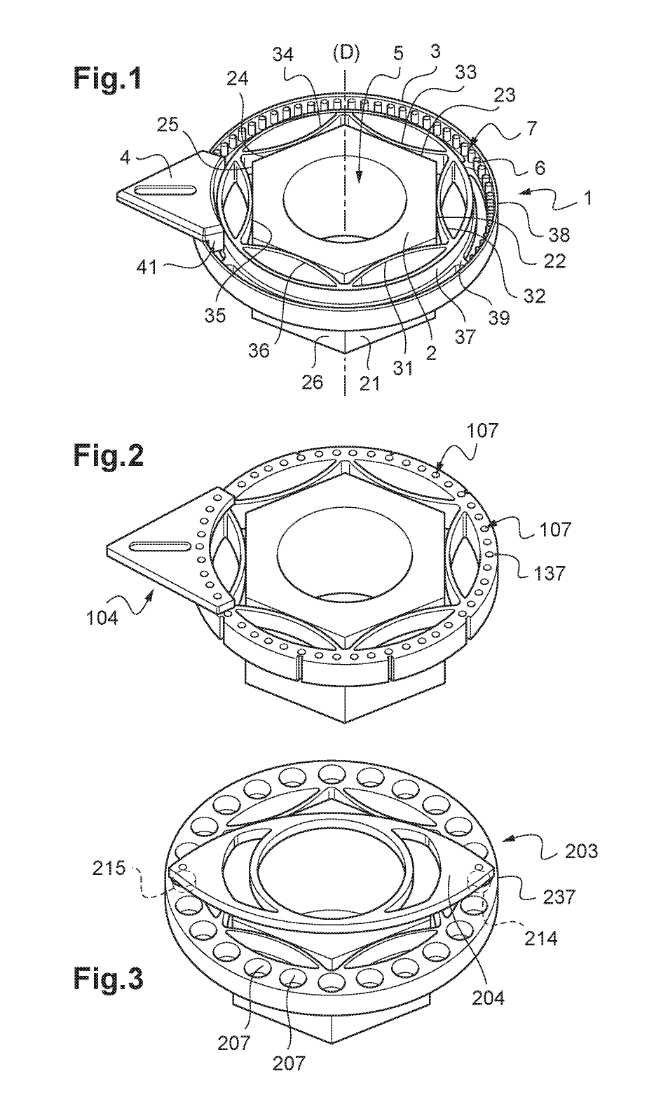

FIG. 1 shows one example of an indicator device according to one embodiment of the invention, mounted on a hexagonal nut.

FIG. 2 shows one example of an indicator device according to another embodiment of the invention mounted on a hexagonal nut.

FIG. 3 shows one example of an indicator device according to a further embodiment of the invention mounted on a hexagonal nut.

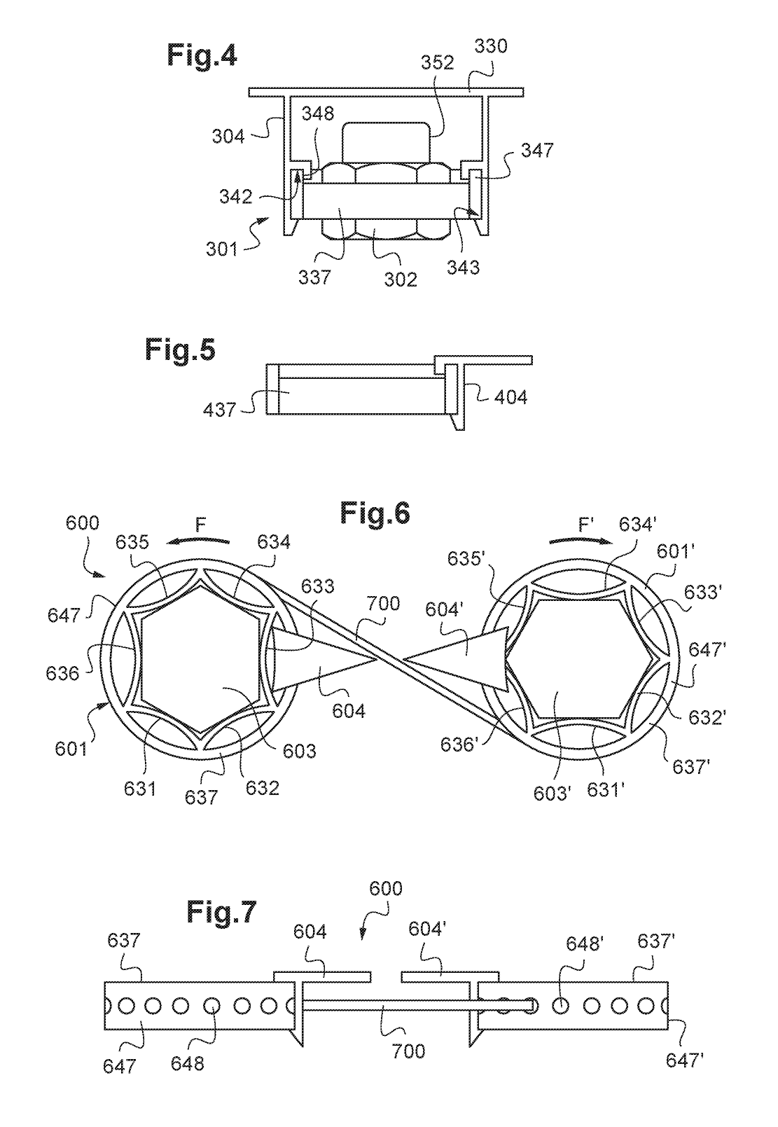

FIG. 4 shows one example of an indicator device according to a still further embodiment of the invention mounted on a hexagonal nut.

FIG. 5 is a diagrammatic sectional view of one example of an indicator device according to a still further embodiment of the invention.

FIG. 6 is a diagrammatic view from above of a retaining assembly according to one embodiment of the invention with two nuts.

FIG. 7 is a diagrammatic sectional view of a retaining assembly according to the embodiment from FIG. 6.

Proportions are not necessarily respected from one figure to another.

On the other hand, identical references from one figure may be used in another to designate identical or similar elements.

Referring to FIG. 1, a device 1 indicating the loosening of a hexagonal nut 2 is shown.

The nut 2 defines a through orifice 5 with an internal thread, not shown, to receive an externally threaded rod, not shown. That orifice extends along a longitudinal axis (D). The nut 2 is screwed onto the externally threaded rod by rotation about this longitudinal axis (D).

The indicator device 1 comprises a body 3 and a marking element, here an arrow 4 fixed to this body 3.

The body 3 comprises two concentric circular ring elements 37, 38 fastened to one another by spacers 39.

The body 3 is made in one piece with six leaf springs 31, 32, 33, 34, 35, 36, for example by 3D printing.

Each leaf spring 31, 32, 33, 34, 35, 36 is fastened by its two ends to an internal wall of the circular element 37 and each end of a leaf spring is fixed near the adjacent leaf spring.

The six leaf springs 31, 32, 33, 34, 35, 36 thus form a pseudo-hexagonal structure corresponding to the shape of the section of the nut.

When the nut 2 is received in this pseudo-hexagonal structure, each leaf spring 31, 32, 33, 34, 35, 36 is in compression and exerts a radial force against a corresponding plane face 21, 22, 23, 24, 25, 26 of the nut.

The indicator device 1 therefore bears against the plane faces 21, 22, 23, 24, 25, 26 of the nut 2: if the edges of the nut between two plane faces are damaged or poorly defined, the quality of the fixing of the indicator device 1 remains unchanged.

The external circular element 38 defines excrescences 6 and grooves 7 between two adjacent excrescences. These means 6, 7 have a width in the radial direction that is relatively small, of the order of a millimeter or of a tenth of a millimeter.

The arrow 4 comprises a fixing portion 41 extending tangentially and longitudinally and defining means (not visible in FIG. 1) complementary to the means 6, 7, here excrescences and grooves similar to the excrescences 6 and to the grooves 7.

The internal circular element 37 is separated from the circular element 38 by a distance sufficient for the fixing portion 41 to be able to be introduced between these circular elements 37, 38 but sufficiently small to force the excrescences 6 to fit in the grooves of the arrow 4 and vice versa.

To fix the arrow 4 to the body 3 it therefore suffices to introduce the fixing portion 41 between the circular elements 37, 38.

Thanks to the circular shape of the elements 37, 38 and thanks to the small dimensions of the means 6, 7 providing the cooperation with the arrow, the arrow 4 can be positioned relative precisely, with a precision of the order of a few degrees.

Referring to FIG. 2, the indicator device comprises a single ring element 137 in which are defined a plurality of tens of regularly spaced holes 107.

The arrow 104 is similar to the arrow 4 from FIG. 1 except that the fixing part 41 has been replaced by a plurality of studs (not visible in FIG. 2) disposed and sized so as to be receivable in holes 137.

The arrow 104 can therefore comprise about 10 studs.

In the FIG. 3 embodiment, the marking element 204 extends radially toward the interior of the body 203.

The body 204 comprises a single circular ring element 237.

The marking element 204 extends over all of a diameter of this circular ring element 237.

The marking element 204 extends between two points 214, 215 and is eye shaped.

The circular element 237 defines a plurality of bores 207, for example approximately 25 bores.

Each bore 207 may have a diameter of 1-3 millimeters and a depth of 4-5 millimeters for example.

The marking element comprises two lugs (not visible in FIG. 3) fastened to the points 214, 215, respectively. Each lug may be received in a respective bore, thus enabling the marking element 204 to be disposed with a chosen orientation.

Referring to FIG. 4, a loosening indicator device 301 is mounted on a nut 302 screwed onto an externally threaded rod 352.

This device 301 comprises a circular ring element 337 fastened to springs that are not visible in this figure, those springs exerting radial forces against the plane faces of the nut 302.

The device 301 further comprises a marking element 304 mounted on the ring element 337.

The ring element 337 defines at its perimeter a rim 347 with an internal wall 348.

The marking element 304 is adapted to be clipped against this circular element 337. To this end the element 304 defines a recess 342 to receive a top edge of the rim 347 and a shoulder 343 to receive a bottom edge of the rim 347. The marking element therefore bears against the internal wall 348.

Although this is not seen in the FIG. 4 sectional view, the marking element 304 comprises a marking part 330 that is not symmetrical with respect to the longitudinal axis, for example in the shape of an eye.

In the FIG. 5 embodiment the marking element 404 is clipped onto the ring element 437 in the same way that the element 304 is clipped onto the element 337. In this example, however, the marking element 404 comprises an arrow extending radially toward the exterior of the ring 437.

Referring to FIGS. 6 and 7, a retaining assembly 600 comprises two retaining devices 601, 601′, for example two indicator devices provided with leaf springs 631, 632, 633, 634, 635, 636, 631′, 632′, 633′, 634′, 635′, 636′.

FIG. 6 is highly diagrammatic and in reality most and advantageously all of the leaf springs bear radially against a corresponding nut plane face.

The indicator devices 600, 600′ comprise circular ring elements 637, 637′ onto which are clipped respective arrows 604, 604′.

These ring elements 637, 637′ define on their external walls 647, 647′ orifices 648, 648′ for fixing a metal wire 700.

This wire 700 is fixed slantwise so that if one nut 603 tends to loosen, following a movement as shown by the arrow F, the other nut 603′ is driven in movement in the direction opposite to the direction indicated by the arrow F′, i.e. this second nut 603′ would be tightened.

This arrangement, connecting the nuts to one another, can therefore participate in maintaining the nuts tightened, because the movement of one nut is compensated by a contrary movement of the other nut.

1.-10. (canceled)

11. A device for indicating loosening of a rotary element of a screw-and-nut system, this rotary element being intended to be screwed in and out by a movement in rotation about a longitudinal direction (D), said rotary element comprising a portion of polygonal section in a plane normal to the longitudinal direction, said polygonal section portion defining a plurality of plane faces, said indicator device comprising
a body intended to be mounted on the rotary element,
a marking element extending radially, fastened to the body to indicate the angular position of the rotary element,
characterized in that the loosening indicator device further comprises
at least one spring fastened to the body so that when the body is mounted on the polygonal section portion each spring exerts a radial bearing force on a corresponding plane face of the rotary element.

12. The loosening indicator device as claimed in claim 11, in which the spring comprises a leaf spring.

13. The loosening indicator device as claimed in claim 12, in which the body comprises at least one ring element of circular shape.

14. The loosening indicator device as claimed in claim 13, in which a plurality of leaf springs are fastened by their two ends to an internal wall of the ring element so as to form a pseudo-polygonal structure to receive the polygonal section portion of the rotary element.

15. The loosening indicator device as claimed in claim 13, in which at least one ring element of circular shape and the marking element each define cooperation means complementary to one another with a depth in the radial direction varying according to the angular position with a particular pitch.

16. The loosening indicator device as claimed in claim 11, in which the marking element can be clipped on to the body.

17. The loosening indicator device as claimed in claim 11, in which the body and the springs are made in one piece from metal.

18. The loosening indicator device as claimed in claim 11, in which the body comprises means for fixing it to a linear element of the metal wire or cable type.

19. An assembly for maintaining in a tightened position a plurality of rotary elements of respective screw-and-nut systems, each rotary element being intended to be screwed in and out by a movement in rotation about a longitudinal direction, this assembly comprising
at least two loosening indicator devices as claimed in claim 18, in which said devices are adapted to be mounted on respective rotary elements so as to prevent all relative movement in a tangential direction,
the linear element fixed to two loosening indicator devices via the respective corresponding fixing means so that a movement loosening one of the rotary elements corresponding to one of these indicator devices drives the rotary element corresponding to the other of these indicator devices in rotation in the tightening direction.

20. A use of an indicator device as claimed in claim 11 or of a maintaining assembly as claimed in claim 19 in a petrochemical installation.
